(19) United States
(12) Patent Application Publication
(10) Pub. No.: US 2011/0191394 A1
(43) Pub. Date: Aug. 4, 2011

(54) METHOD OF PROCESSING LOG FILES IN AN INFORMATION SYSTEM, AND LOG FILE PROCESSING SYSTEM

(76) Inventors: Joel WINTEREGG, Yverdon-les-Bains (CH); Raffael Maio, Cossonay (CH)

(21) Appl. No.: 12/696,130

(22) Filed: Jan. 29, 2010

(51) Int. Cl. G06F 17/30

(52) U.S. Cl. 707/822; 707/E17.01; 707/E17.005

(57) ABSTRACT

A system and method of processing log files in an information system having a plurality of log file sources, by collecting log files from the log file sources at a log file acquisition unit and storing the log files in a log file storage unit. On an on demand basis, a portion of stored log files is selected and the selected log files are processed in order to obtain a normalized log file data. The system also relates to the corresponding log file processing system for an information system.

### FIELD OF THE INVENTION

The present invention relates to a method of processing log files in an information system. It also relates to the corresponding log file processing system.

### BACKGROUND OF THE INVENTION

Information systems involving complex IT architectures are now widely used. Such information systems often include large amounts of equipments and applications, such as Windows servers, UNIX servers, business applications, Enterprise Resource Planning (ERP) software, application servers, workstations, switches, firewalls, network printers, etc, often logging large numbers of events in various log files: Log files are used for storing various events or conditions that affected a particular equipment or application, and are widely used for error management, network planning and so on.

Usually, each log file is stored in the equipment that generates it, making access to log files in all the equipments in a network very tedious. Therefore, specific equipments have been suggested for collecting in a single place and for processing log files generated by different equipments.

However, log files are produced by various equipments of different manufacturers in various, often non compatible codes or formats. The use of different log files formats involves complex normalization methods and systems.

For instance, US 2007/0283194 generally relates to log message processing such that events can be detected and alarms can be generated. A log manager collects log data using various protocols (e.g. Syslog, SNMP, SMTP, etc.) and related to different events. That is, the log manager may communicate with the network equipments using appropriate protocols to collect log messages there from. The log manager may then determine events (e.g., unauthorized access, logins, etc.) from the log data and transfer those events to an event manager. The event manager may analyze the events and determine whether alarms should be generated there from.

US2002/0138762 describes a system and method for security management comprising log archival and reporting using a scalable architecture for larger scale global data networks. The system comprises a log collection unit, interfacing with a data analysis and log archival unit, and a data and system access unit interfacing with the data analysis and log archival unit. The log collection unit comprises a log collector manager for managing log collection from a plurality of log collectors interfacing with one or more security devices. The log collection unit transfers log files to a storage manager and a data analysis manager, connected to a data analysis store. The system provides for separation of log file analysis and archival of log files, which improves scalability of the system.

Such prior art systems involve real time processing and standardization of log files. The original log file (before standardization) is usually not saved. Such configuration causes many important drawbacks.

First, the standardization of log files is based on predefined standardization rules for converting one logged event from one format to another standardized format. Since the events are processed and converted in real time, the process requires the availability of standardization rules immediately after log file creation. However, at this point, some standardization rules may not be available, or not up-to-date. For instance, new equipments may be installed or released before the corresponding standardization rules are defined and installed in the log manager. This may lead to false, incomplete or unreliable standardized log files results.

Moreover, since the size of the standardized log files is usually much larger than the size of the original log files, storing the processed and translated/standardized data involves very large databases, and waste of storage space.

Finally, in some situations the standardization of the log files results in irremediable loss of information, which may prevent reliable diagnostic and maintenance. A simulation of the event has to be made when one wants to retrieve the original log file corresponding to this data, for example in order to test the effect of a particular condition on the network. Such a simulation is not always possible or desirable.

In other systems, a copy of the raw log file is stored along with a processed and translated version of the same log file. Although this copy is useful for avoiding the loss of information due to standardization, it generates an even higher redundancy and increase of requested storage space.

### SUMMARY OF THE INVENTION

A general aim of the invention is therefore to provide an improved method of processing log files and a log file processing system.

A further aim of the invention is to provide such method of processing log files and log file processing system, which offers more possibilities for IT (Information Technology) forensics and for a proactive monitoring of heterogeneous IT components.

Still another aim of the invention is to provide such method of processing log files and log file processing system, providing more accurate results.

Yet another aim of the invention is to provide such method of processing log files and log file processing system, requiring less processing and storage resources.

These aims are achieved thanks to the method of processing log files and log file processing system defined in the claims.

There is accordingly provided a method of processing log files of an information system having a plurality of log file sources, comprising:
collecting log files from said log file sources at a log file acquisition unit;
storing said log files in a log file storage unit;
on an on demand basis, selecting a portion of stored log files;
processing said selected log files in order to obtain normalized log file data.

The selection may be based on events, severities, dates, applications, etc.

In a preferred embodiment, the normalized data are not permanently stored, in order to save some memory capacity. As these data may be easily and quickly obtained, the user is not penalized.

In a preferred embodiment, the genuine log files that are stored in the log file storage unit are used for displaying information that does not need normalization. For example, a chart may be computed for displaying the number of events during a certain period, or in a certain portion of the network.

Advantageously, the method further comprises a step consisting in referring to at least one log file dictionary, for interpretation of selected log files as part of said processing step and mapping of unprocessed event to normalized events.

Before processing of selected log files, an update of log file dictionaries is preferably made.

In a preferred embodiment, the normalized log file data are analyzed in order to provide on demand forensics. The forensics may involve firewall forensics, network forensics, database forensics, mobile device forensics, etc.

The invention also provides a method of processing log files of an information system having a plurality of log file sources, comprising:
collecting log files from said log file sources at a log file acquisition unit;
storing said log files in a log file storage unit;
receiving from a log file selection unit a selection of stored log files to be processed;
processing said selected log files in order to obtain normalized log file data.

On-demand processing of a selection of potentially relevant log files among the saved log files enables the user to obtain quick, reliable and cost-effective processing of the saved log files.

The invention also provides a log file processing system for an information system, comprising:
a log file acquisition unit, for acquisition of log files from a plurality of log sources connectable to said system;
a log file storage unit, for storing log files received from log sources;
a log file selection unit, for identification of log files to be processed among the stored log files;
a log file processing unit, comprising a normalization engine, for normalization of log files in a given format;
log file interpretation dictionary, accessible from said processing unit and providing a database of interpretation codes for the normalization engine;
said log file selection unit is adapted for on-demand selection of log files to be normalized.

On-demand normalization based on a specific selection of the log files to be processed after the log files have been stored provides many advantages. For instance, the dictionaries used during processing may be updated up to processing time. It is thus particularly advantageous to delay the processing of data up to the period during which the processed data are really required. Therefore, updates of dictionaries may include the most recent modifications and the processing results are more reliable. Moreover, in most systems, processed/normalized log files are required only on occasional basis and usually for short time-slots. Important processing savings are thus possible due to the fact that only a portion of the data is processed. In fact, in usual cases, log files generate huge data volumes, but most of this data do not have to be normalized.

Advantageously, the log file storage unit is adapted for continuing the storage of the log files selected for processing, in their original raw format. The storage of original log files used for processing is continued for any eventual further processing of the same data. In an embodiment, a selected portion of the data may be stored for later processing. The continued availability of original data allows any type of processing, for any time-slot, and any type of event.

Advantageously, the system has a normalization engine installed with the appropriate tools to convert an infrastructure's heterogeneous log data into a standard format, such as the IDMEF-RFC format (Intrusion Detection Message Exchange Format) or XDAS (Distributed Auditing System). This eliminates the time-consuming task of governing different log languages, and enables uniform correlation, search and analysis to form a high-level service abstraction.

The log file processing system also preferably comprises a forensic module for analysis of the normalized log files.

### BRIEF DESCRIPTION OF THE DRAWINGS

The foregoing and other purposes, features, aspects and advantages of the invention will become apparent from the following detailed description of embodiments, given by way of illustration and not limitation with reference to the accompanying drawings, in which:

FIG. 1 is a schematic diagram showing the structure of a log file processing system in accordance with the invention;

FIG. 2 illustrates a flow diagram illustrating the main steps required for processing log files;

FIGS. 3A and 3B are a screen copy showing an example of forensic session with processing of log files in accordance with the invention;

FIGS. 4A and 4B are a screen copy showing an example of real-time view based on the raw log files before processing.

### DETAILED DESCRIPTION OF THE INVENTION

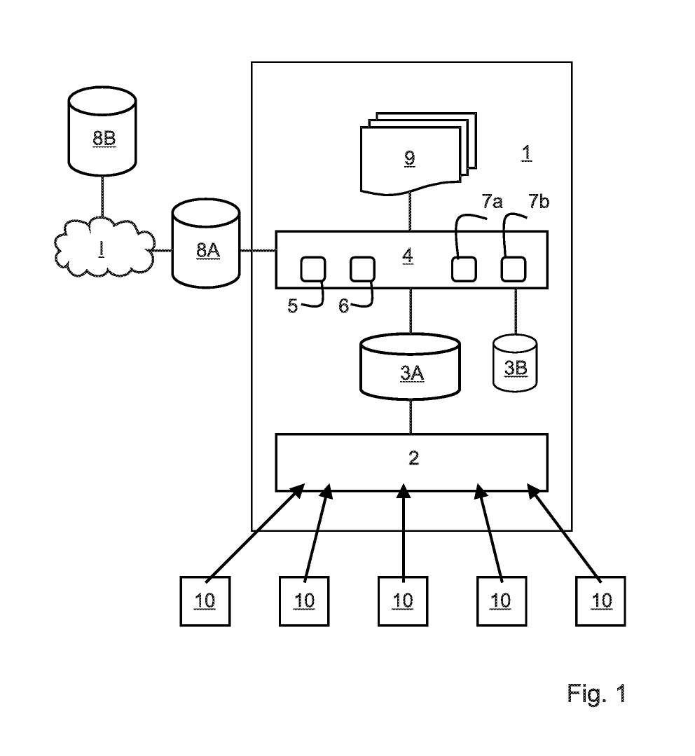

Referring to FIG. 1, the log file processing system 1 comprises at least one log file acquisition unit 2, for collecting the log files from the various information system components 10 to be monitored. One or more log file storage units 3A are connected to the acquisition unit 2, to receive and store the collected raw log files, before normalization. The equipments 10 may involve computers, servers, switches, hubs, printers, firewalls, databases, safety material, monitoring material, PDA, smart phones, operating systems, various software and business applications, or any piece of hardware or software module capable to generate log files and which can be reprogrammed to send them to the acquisition unit 2.

In one embodiment, the storage unit 3A is a hierarchical file directory structure, and the log files generated by the various equipments 10 are saved by the acquisition unit 2 directly as files in this structure. The log file acquisition unit 2 determines the name and path of each file in this structure, create new directory paths for example when new equipments are added, and possibly adds a time stamp, and/or a signature, and/or a parity check data, to each log file stored in this structure. The log file acquisition unit can also perform limited editing of the logs, for example in order to adapt the severity associated with each event.

A log file-processing unit 4, connected to the storage units 3, is used for normalization of log file data and any other further data processing of the normalized log files. In the illustrated example, the processing unit 4 comprises a normalization engine 6 specifically designed for the normalization task, for instance to convert the heterogeneous log data into a standard IDMEF-RFC format (Intrusion Detection Message Exchange Format). Others standard formats are also possible. The normalized logs are preferably stored in a relational database 3B for fast retrieval, filtering, sorting and processing.

One or several log file normalization dictionaries 8A, 8B are connected or integrated with the log file processing system 1. In the illustrated example, a dictionary 8A is directly connected to the log file processing unit 4 and can be updated of synchronized with an external dictionary 8B accessible over the Internet I. The dictionary 8A contains the required conversion and adaptation data and rules to enable the normalization engine 6 to transform the raw log file data collected from the multi-standard equipments 10 into a normalized uniform format. Thanks to the normalization engine 6, log files in various non-compatible formats in the file structure 3A can be normalized and transformed into a single format into the database 3B, allowing uniform data processing for all pieces of equipment, even from different types and/or from different manufacturers.

The normalized data in the relational log database 3B are then accessed by a data analysis engine 7a and/or a forensic module 7b, which use the normalized data for system analysis, to prepare historic, or forensic or statistical analysis. Processed data 9 are schematically shown in FIG. 1. The data analysis engine 7a and the forensic module 7b may comprise database queries, forms and/or front-end applications for processing and accessing the records in database 3B.

System analysis may involve information system monitoring, failure analysis and diagnostics, intrusion control, forensic computing, user or material statistical analysis, troubleshooting, process analysis, service level monitoring, security metrics monitoring, processing and maintaining evidence of events in a network, etc.

Log file collection and storing in file structure 3A may be performed on a real-time basis, or at pre-programmed time intervals. In one embodiment, the equipments are programmed to store their log files in the system 1, and/or to send copies of those log files to this system 1. However, normalization into database 3B and data analysis are performed on demand. This may be after a decision or instructions received from a monitoring program, a user, or other material or program. A log file selection unit 5 is advantageously provided for a rigorous selection of the relevant log files to be processed. Thus, the log file processing system 1 performs analysis after a request or a decision, on demand. This avoids the time and resource consuming processing of all log files. Considering that only a portion of the log files is relevant for a complete analysis, such complete processing is generally not required. Therefore, the log file processing system and method of the invention enable important storage and processing material savings. Moreover, since only a very small portion of the available log files are converted, the size of the database 3b of normalized logs can be very small, allowing extremely fast processing, filtering and sorting of log data in this database.

Moreover, on-demand processing based on a specific selection of the log files to be processed further enables to perform more complete updates of the dictionaries 8A. Thanks to this feature, the normalization engine 6 may provide more reliable results.

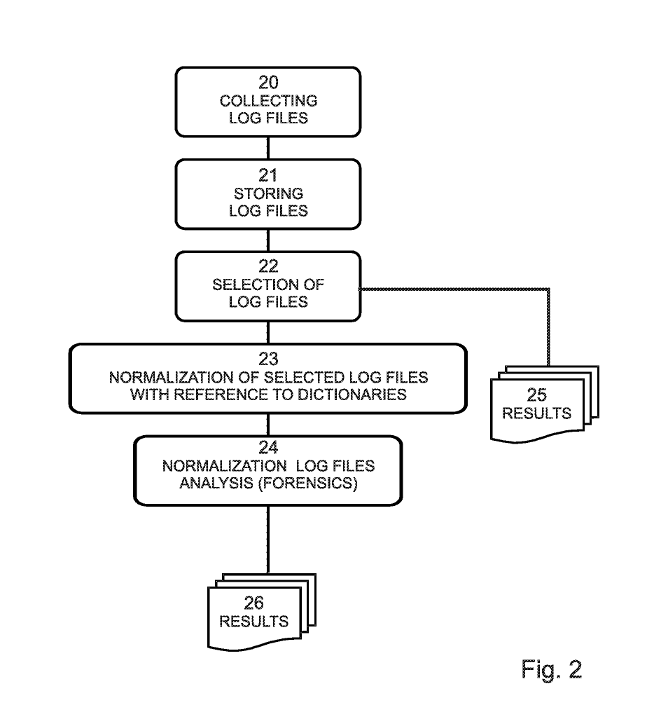

FIG. 2 show different steps of the method of processing log files in accordance with the invention. At step 20, the log files from various equipments 10, such as computers, servers, switches, hubs, smart phones, PDA, network equipments, security equipments, etc, are continuously stored (step 21) in the storage unit 3A, for example as indexed files in a file structure. As indicated, the log file acquisition unit 2 can perform some basic pre-processing on those files, for example pre-processing based on the headers and sources of the log files only. This pre-processing may comprise for example:
Determining the name of each log file to store in the storage unit 3A; and/or
Determining the path of each log file in the storage unit 3A; and/or
Adding a time stamp to each log file; and/or
Adding an identification of the originating equipment to each log file; and/or
Adding a signature to each log file, in order to prove its integrity; and/or
Computing a hash of each log file, in order to prove its integrity; and/or
Applying a specific processing to log files generated by business application; and/or
Computing a parity check of each data, in order to prove its integrity; and/or
Modifying some events in the log file, for example in order to adapt the severity of each event depending on user predetermined preferences and/or on the type and manufacturer of each equipment 10, to add a date and time as determined in the log file processing system 1, or to add other metadata.

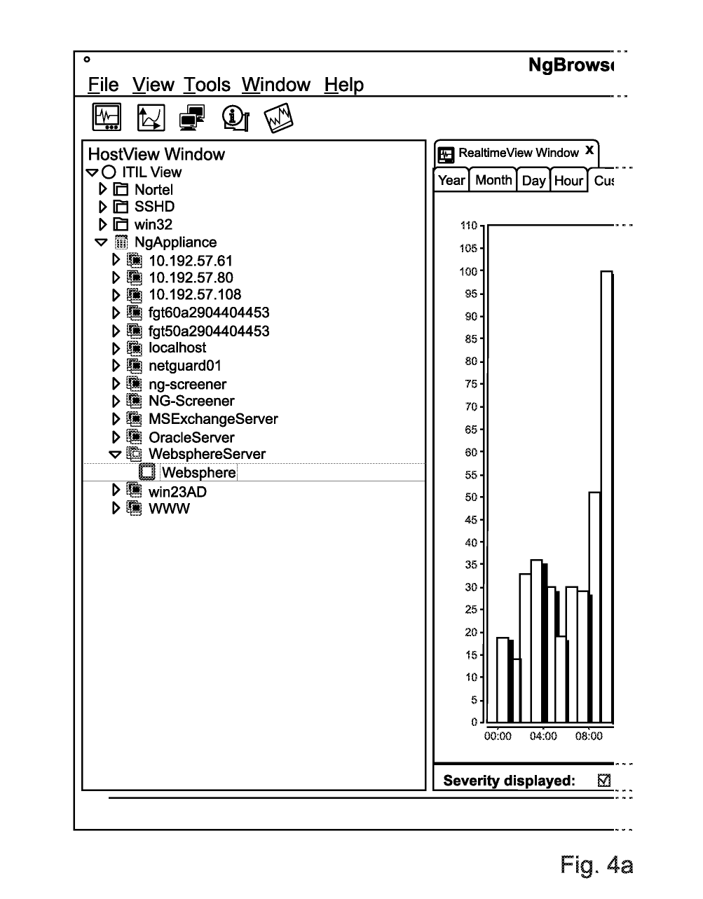

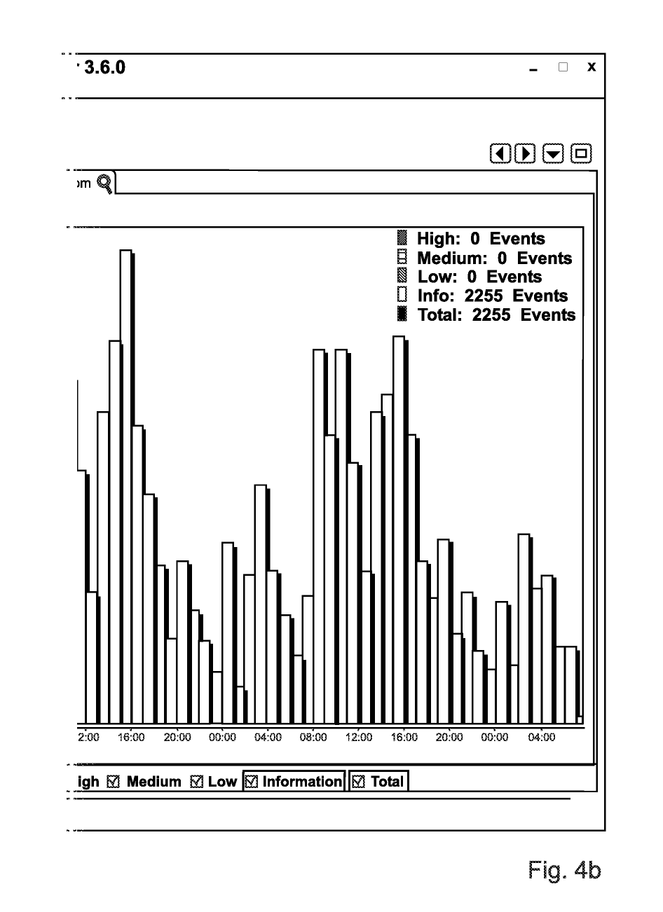

At step 25, the data collected in the storage unit 3A are displayed in a real-time view, such as the real-time view displayed on FIGS. 4A and 4B. This real-time view is continuously updated to present basic information relating to the flow of incoming data, for example the number of events received during successive time periods, possibly classified by their severity. Thus, a user who watches this real-time view can observe and react when an unexpected number of events with some severity are generated during a specific time period or in some parts of the network. This real-time view may be adapted, for example in order to change the time frame, to limit the real-time view to events generated in some equipments or in some parts of the network, and/or to some type or severity of events. This real-time view does not provide any detail on each specific event, except its severity. In one embodiment, alarms are automatically generated when certain conditions on the raw data are met, for example when some types of events are detected. The alarm may trigger the sending of a message, such as an e-mail or SMS, to an IT manager.

When a user or a system or a computer program requires a more detailed view on one or some events, a selection of a set of log files in storage unit 3A is received from the log file selection unit 5, at step 22. The selection may be based on one or more events to be monitored or controlled, or on a resource, on a user, or any criteria relating to the network management and/or computer forensic. The selection may be pre-programmed, or prepared on the spot, for instance following a system failure or intrusion to be analyzed. For example, a user may indicate a specific time window to restrict the selection to all events occurring in various equipments of the network, or in a selected portion of the network, during this time window. Other selection criteria include for example a specific company department (such as finance, R&D etc), a subnetwork, a type of equipment (for example only events related to switches), a manufacturer of equipment, a user-entered selection of equipments, a type or severity of events, etc. Selection criteria may be predefined, stored by the user, or loaded from the Internet, and shared among users. For example, one user may determine selection criteria useful for understanding some specific condition, for solving a problem or for producing a specific report, and share those criteria with other users.

Based on the selection criteria, a log file selection is obtained by the log file selection unit 5, and the corresponding log files are extracted from the storage unit 3A for normalization. Thus, at step 23, the normalization engine 6 performs a log file normalization of the selected log files and stores the normalized data into the relational event log database 3b. Thanks to step 22, allowing a specific selection of the relevant log files to be analyzed, only a portion of the log files stored at step 21 are normalized and further analyzed. Thus, although the normalization itself may be time consuming (depending on the number of events to process), the output of this process is a relatively small relational database which can be extremely fast for further processing and for generating reports and views.

The normalization process includes a translation of the events in a standard event description format. Thus, similar events that may be described differently in the logs generated by different equipments will be translated during this normalization in order to generate a similar or identical event description, using an appropriate taxonomy. The normalization can also concern the severity associated with each event. In one embodiment, the normalization includes the addition of a description to each event. For example, a particular error indicated by an error number may be replaced or completed by a description of the error, and of the solution, and/or by a link to the error description and solution.

The normalization process uses the dictionary 8A in which translation rules are defined. Since new equipments may be introduced at any time in the network, this dictionary is preferably updatable, for example on request when the user selects an update command on the user interface, or periodically. In one embodiment, this dictionary 8A is automatically updated before each request for conversion if a new dictionary is available. The update of a dictionary is advantageously downloaded over the Internet from one central dictionary repository 8b.

If the normalization process is unsatisfactory, for example when the dictionary rules that are required for normalizing events generated from a particular new equipment are not yet available, the user may decide to retry at a later stage, when new rules have been made available. For example, he may search and download from the Internet a suitable set of rules adapted to the equipment and stored in dictionary 8A. User can also edit their dictionary 8a themselves and introduce new normalization rules or edit description of events. In one embodiment, those new dictionary entries are synchronized with the central dictionary 8B and made available to other users, possibly after validation by a supervisor.

The raw log files remain available in the storage unit 3A for further processing either locally or in a remote location, for instance via a distant service provider for further technical or legal expertise.

The normalized data in database 3B are used at step 24 for a complete analysis by the data analysis engine 7a and/or the forensic module 7b. Final results are displayed at step 25. After use and display, the normalized data in database 3B are deleted in order to keep the size of database 3B small and processing of data in this database fast and efficient.

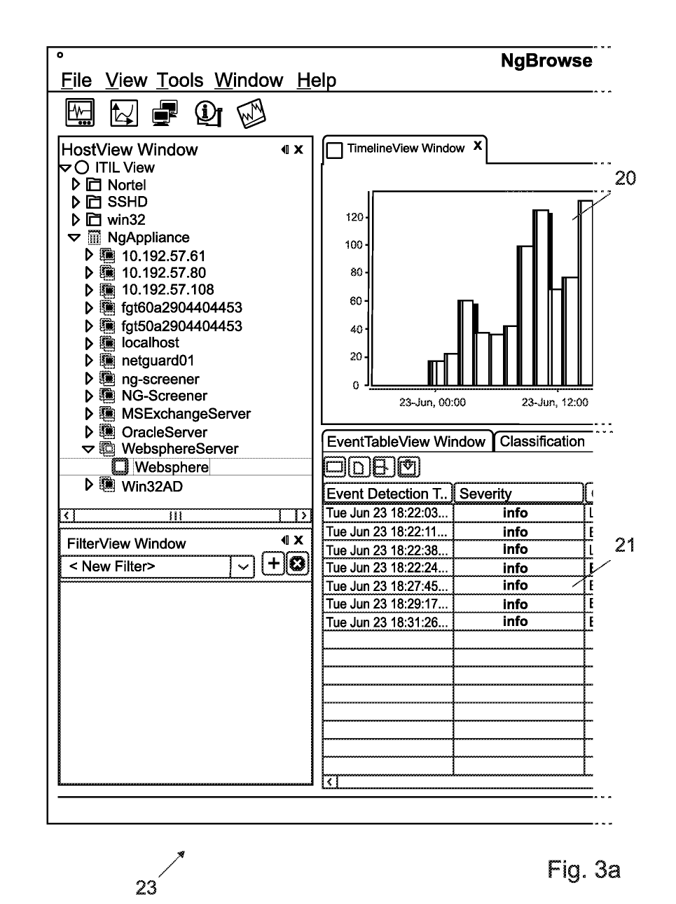

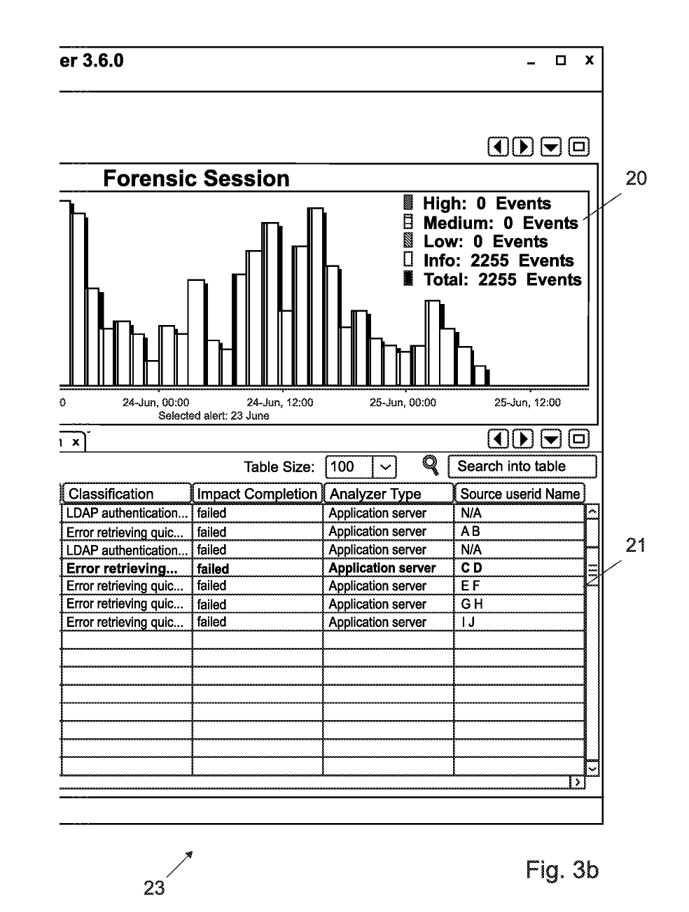

FIGS. 3A and 3B show a screenshot illustrating an example of report that may be computed and displayed based on the normalized data potentially obtainable at step 25. The screenshot shows the results of a forensic session involving an application server. A time frame and a subset of the equipments 10 are selected, generating an on-demand normalization of the log files generated by the selected equipments during the selected time frame, and storing of corresponding data in database 3B. During step 25, various reports, forms and charts can be selected by the user, computed and displayed based on those selected data.

In the example of FIG. 3, the view 23 comprises a scrollable list 21 and a chart with an overview of the selected events in this time frame and relating to the selected equipments. The events selected in database 3b may be sorted and/or further filtered by their severity, by the originating equipment, by time etc. Each event in the list can be individually selected in order to display additional information, including for example the raw data received from the equipment, additional description and comments on the event, one or several links to related pages or documents, etc.

Other diagrams, for example pie charts, may be used for indicating the number of events of some severity generated during a specific time frame by each equipment, or by each portion of the network.

The list of events selected in this forensic view can preferably be stored, for example as XML file, and/or sent externally, for example as an email attachment, for further analysis. Similarly, reports based on this selection may be saved, exported and printed.

These examples show that by clearly presenting all information, operators are able to quickly obtain an overview of infrastructure performance and identify and investigate any hardware, service level or security issues. Unobtrusive, real-time audit event collection enables proactive detection, identification, and tracking based on user-defined parameters, troubleshooting and trend identification.

1. A method of processing log files in an information system having a plurality of log file sources, comprising:
collecting log files from said log file sources at a log file acquisition unit;
storing said log files in a log file storage unit;
on an on demand basis, selecting a portion of stored log files;
processing said selected log files in order to obtain normalized log file data.

2. The method of claim 1, further comprising:
referring to at least one log file dictionary, for interpretation of selected log files.

3. The method of claim 1, further comprising:
analyzing the normalized log file data on order to provide on demand forensics.

4. The method of claim 1, further comprising:
before processing of selected log files, updating log file dictionaries.

5. A method of processing log files in an information system having a plurality of log file sources, comprising:
collecting log files from said log file sources at a log file acquisition unit;
storing said log files in a log file storage unit;
receiving from a log file selection unit a selection of stored log files to be processed;
processing said selected log files in order to obtain normalized log file data.

6. The method of claim 5, further comprising:
referring to at least one log file dictionary, for interpretation of selected log files.

7. The method of claim 5, further comprising:
analyzing the normalized log file data on order to provide on demand forensics.

8. The method of claim 5, further comprising:
before processing of selected log files, updating log file dictionaries.

9. A log file processing system for an information system, comprising:
a log file acquisition unit, for acquisition of log files from a plurality of log sources connectable to said system;
a log file storage unit, for storing log files received from log sources;
a log file selection unit, for identification of log files to be processed among the stored log files;
a log file processing unit, comprising a normalization engine, for normalization of log files in a given format;
log file interpretation dictionary, accessible from said processing unit and providing a database of interpretation codes for the normalization engine;
wherein said normalization engine is adapted for on-demand processing of selected log files.

10. The log file processing system of claim 9, wherein said log file storage unit is adapted for continuing the storage of the log files selected for processing.

11. The log file processing system of claim 9, wherein the normalized log file data are analyzable in order to provide on demand forensics.

12. The log file processing system of claim 9, further comprising a forensic module for analysis of the normalized log files.

13. A log file processing system for an information system, comprising:
a log file acquisition unit, for acquisition of log files from a plurality of log sources connectable to said system;
a log file storage unit, for storing log files received from log sources;
a log file selection unit, for identification of log files to be processed among the stored log files;
a log file processing unit, comprising a normalization engine, for normalization of log files in a given format;
log file interpretation dictionary, accessible from said processing unit and providing a database of interpretation codes for the normalization engine;
wherein said log file selection unit is adapted for on-demand selection of log files to be normalized.

14. The log file processing system of claim 13, further comprising a forensic module for analysis of the normalized log files.
